(19) United States
(12) Patent Application Publication
(10) Pub. No.: US 2002/0141346 A1
(43) Pub. Date: Oct. 3, 2002

(54) Method for approximating minimum delay routing

(75) Inventors: Jose Joaquin Garcia-Luna-Aceves, San Mateo, CA (US); Srinivas Vutukury, Sunnyvale, CA (US)

Correspondence Address: John P. O'Banion, O'BANION & RITCHEY LLP, Suite 1550, 400 Capitol Mall, Sacramento, CA, 95814, US

(73) Assignee: THE REGENTS OF THE UNIVERSITY OF CALIFORNIA

(21) Appl. No.: 09/945,101

(22) Filed: Aug. 31, 2001

Related U.S. Application Data
(60) Provisional application No. 60/229,824, filed on Aug. 31, 2000.

(51) Int. Cl. H04J 1/16

(52) U.S. Cl. 370/238; 370/386

(57) ABSTRACT

A practical framework and “near-optimal” routing method which approximates minimum delay routing within a network. A framework for approximating Gallager's minimum-delay routing problem (MDRP) is described with methods for implementing the approximation on real networks subject to frequent topology changes and bursty traffic. The computation of minimum-delay paths is divided into two parts, (1) the establishment of multiple loop-free paths of unequal cost to a destination, (2) allocation of flows to minimize delays using short-term link-cost information. The method provides multi-path routing which overcomes the implementation limitations of optimal routing algorithms, such as oscillatory behavior, and the delays associated with shortest-path routing methods, while avoiding undetected loops.

### BACKGROUND OF THE INVENTION

1. Field of the Invention

The present invention generally pertains to network traffic routing, and more particularly to a method of approximating minimum delay routing and providing loop-free multi-path routing within a real network.

2. Description of the Background Art

The conventional approach to routing in computer networks consists of using a heuristic to compute a single shortest path from a source to a destination. Single-path routing is very responsive to topological and link-cost changes; however, except under light traffic loads, the delays obtained with this type of routing are far from optimal. Furthermore, if link costs are associated with delays, single-path routing exhibits oscillatory behavior and becomes unstable as traffic loads increase. On the other hand, minimum delay routing approaches can minimize delays only when traffic is stationary or very slowly changing.

The computing of a single shortest path from a source to each destination using some heuristic link-cost metric. Typically, the link-cost metric utilized is not directly associated with the transmission and queuing delays over the links and paths. A less common approach to routing is that of defining the routing problem as an optimization problem (e.g., multicommodity problem) with a specific objective function, such as minimizing delays or maximizing throughput, and solving the problem using any of several known optimization techniques. These two traditional approaches to routing have inherent strengths and drawbacks.

In order to provide minimum delays, all optimal routing algorithms require the input traffic and the network topology to be stationary or very slowly changing (quasi-static), and require a priori knowledge of global constants that guarantee convergence of the routing algorithm. This makes optimal routing algorithms impractical for real networks, because in real networks traffic is very bursty at any time scale and the network topology frequently experiences changes. Moreover, is it not possible to define global constants that are effective for all input traffic patterns.

Contrary to optimal routing algorithms, routing algorithms based on single shortest-path heuristics rapidly adapt to changing network conditions, and their use is far more preferable than optimal routing algorithms for implementation within real networks. A major shortcoming of single shortest-path routing, however, is that the use of these single-path heuristics result in routes which are subject to delays which can greatly exceed those achievable using optimal routing algorithms. In addition, single-shortest-path routing methods become unstable under heavy loads or traffic which may be characterized as bursty when the link-cost metric used in the routing algorithm is related to the delays or congestion experienced over the links.

The fact that shortest-path routing over a single path is far less efficient than optimal dynamic routing and the oscillatory behavior of shortest-path routing when link costs are tied to link delays has been known for many years. However, feasible methods of implementing optimal dynamic routing on a computer network have not been available. The present invention provides a new framework for providing routing paths having a “near-optimum” delay routing and a method of verifying a set of invariants that permit routing-algorithm designers to approximate Gallager's necessary and sufficient conditions for minimum-delay routing with loop-free routing conditions that can be achieved using distributed routing algorithms that do not require any global variables or global synchronization. Furthermore an example is described in which end-to-end delays are comparable to the optimal, while being as fast as today's shortest-path routing schemes.

The following section presents the minimum-delay routing problem (MDRP) as described by Gallager, and Gallager's minimum-delay routing algorithm. Gallager's algorithm is unsuitable for practical networks and internetworks, because its speed of convergence to the optimal routes depends on a global constant, and because it requires that the input traffic and network topology be stationary or quasi-stationary.

2.1 Problem Formulation-MDRP

The minimum-delay routing problem (MDRP) was first formulated by Gallager, and we provide the same description in this section. A computer network G=(N,L) is made up of N routers and L links between them. Each link is bi-directional with possibly different costs in each direction.

Let τⁱⱼ≧0 be the expected input traffic, measured in bits per second, entering the network at router i and destined for router j. Let tⱼⁱ be the sum of τⱼⁱ and the traffic arriving from the neighbors of i for destination j. And let routing parameter φⱼₖⁱ be the fraction of traffic tⱼⁱ that leaves router i over link (i,k). Assuming that the network does not lose any packets, from conservation of traffic we have:

$${t}_{j}^{i} = {τ}_{j}^{i} + {\sum }_{k ∈ {N}^{i}} {t}_{j}^{k} {φ}_{ji}^{k} \qquad ( 1 )$$

where Nⁱ is the set of neighbors of router i. Let fₖⁱ be the expected traffic, measured in bits-per-second, on link (i,k). Because tⱼⁱφⱼₖⁱ is the traffic destined for router j on link (i,k) we have the following equation to find fₖⁱ.

$${f}_{ik} = {\sum }_{j ∈ N} {t}_{j}^{i} {φ}_{jk}^{i} \qquad ( 2 )$$

Note that 0≦fᵢₖ≦Cᵢₖ where Cᵢₖ is the capacity of link (i,k) in bits per second.

Property 1

For each router i and destination j, the routing parameters φⱼₖⁱ must satisfy the following conditions.

1. φⱼₖⁱ=0 if(i,k)∉L or i=j. Clearly, if the link does not exist, there can be no traffic on it.

2. φⱼₖⁱ≧0 This is true, because there can be no negative amount of traffic allocated on a link.

3.

$${\sum }_{k ∈ {N}^{i}} {φ}_{jk}^{i} = 1$$

This is a consequence of the fact that all incoming traffic must be allocated to outgoing links.

Let Dᵢₖ be defined as the expected number of messages or packets per second transmitted on link (i,k) times the expected delay per message or packet, including queuing delays at the link. It is assumed that messages are delayed only by the links of the network and Dᵢₖ depends only on flow fᵢₖ through link (i,k) and link characteristics such as propagation delay and link capacity. Function Dᵢₖ (fᵢₖ) is continuous and convex and tends to infinity as fᵢₖ approaches Cᵢₖ. The total expected delay per message times the total expected number of message arrivals per second is given by the following equation.

$${D}_{T} = {\sum }_{( i , k ) ∈ L} {D}_{ik} ( {f}_{ik} ) \qquad ( 3 )$$

Note that the router traffic-flow set t={tⱼⁱ} and link-flow set f={fⱼⁱ} can be obtained from τ={τⱼⁱ} and φ={φⱼₖⁱ}. Therefore D_{T} can be expressed as a function of τ and φ using Eq. (1) and Eq. (2).

MDRP

For a given fixed topology and input traffic flow set τ={τⱼⁱ}, and delay function Dᵢₖ(fᵢₖ) each link (i,k), the minimization problem consists of computing the routing parameter set φ={φⱼₖⁱ} such that the total expected delay D_{T} is minimized.

2.2 A Minimum Delay Routing Algorithm

Gallager derived the necessary and sufficient conditions that must be satisfied to solve MDRP. These conditions are summarized in Gallager's Theorem stated below.

The partial derivatives of the total delay, D_{T}, of Eq. (3) with respect to τ and φ play a key role in the formulation and solution of the problem; these derivatives are as follows.

$$\begin{matrix}\frac{\partial {D}_{T}}{\partial {τ}_{j}^{i}} = {\sum }_{k ∈ {N}^{i}} {φ}_{jk}^{i} [ {D}_{ik}^{′} ( {f}_{ik} ) + \frac{\partial {D}_{T}}{\partial {τ}_{j}^{k}} ] & ( 4 ) \\ \frac{\partial {D}_{T}}{\partial {φ}_{jk}^{i}} = {t}_{j}^{i} [ {D}_{ik}^{′} ( {f}_{ik} ) + \frac{\partial {D}_{T}}{\partial {τ}_{j}^{k}} ] & ( 5 )\end{matrix}$$

where

$${D}_{ik}^{′} ( {f}_{ik} ) = \frac{\partial {D}_{ik} ( {f}_{ik} )}{\partial {f}_{ik}} ,$$

and is called the marginal delay or incremental delay. Similarly, [symbol] is called the marginal distance from router i to j.

Gallager's Theorem

The necessary condition for a minimum of D_{T} with respect to φ for all i≠j and (i,k)εL is given by:

$$\frac{\partial {D}_{T}}{\partial {φ}_{jk}^{i}} = \{ \begin{matrix}= {λ}_{ij} & {φ}_{jk}^{i} > 0 \\ \geq {λ}_{ij} & {φ}_{jk}^{i} = 0\end{matrix} \} \qquad ( 6 )$$

where λᵢⱼ is some positive number; and the sufficient condition to minimize D_{T} with respect to φ is for all i≠j and (i,k)εL is as follows.

$${D}_{ik}^{′} ( {f}_{ik} ) + \frac{\partial {D}_{T}}{\partial {τ}_{j}^{k}} \geq \frac{\partial {D}_{T}}{\partial {τ}_{j}^{i}} \qquad ( 7 )$$

Eq. (4) shows the relationship between the marginal distance of a router to a particular destination and the marginal distances of its neighbors to the same destination. The conditions for perfect load balancing are indicated by Eq. (5) through Eq. (7), for example when the routing parameter set φ gives the minimum delay. The set of neighbors through which router i forwards traffic towards j is denoted by Sⱼⁱ and is called the successor set.

Under perfect load balancing with respect to a particular destination, the marginal distances through neighbors in the successor set are equal to the marginal distance of the router, and the marginal distances through neighbors not in the successor set are higher than the marginal distance of the router.

Let Dⱼⁱ denote the marginal distance from i to j, i.e.

$$\frac{\partial {D}_{T}}{\partial {τ}_{j}^{i}} .$$

Let the marginal delay D′ᵢₖ(fᵢₖ) from i to k be denoted by lₖⁱ which is also called the cost of the link from i to k.

According to Gallagher's Theorem, the minimum delay routing problem now becomes one of determining, at each router i for each destination j:the routing parameters {φⱼₖⁱ}, Sⱼⁱ, Dⱼⁱ, such that the following five equations are satisfied.

Dⱼⁱ= [symbol] φⱼₖⁱ(Dⱼ^{k}+lₖⁱ) (8)

Sⱼⁱ={k|φⱼₖⁱ>0ΛkεNⁱ} (9)

Dⱼⁱ≦Dⱼ^{k}+lₖⁱ kεNⁱ (10)

(Dⱼ^{p}+lₚⁱ)=(Dⱼ^{q}+l_{q}ⁱ) p,qεSⱼⁱ (11)

(Dⱼ^{p}+lₚⁱ)<(Dⱼ^{q}+l_{q}ⁱ) pεSⱼⁱ qεSⱼⁱ (12)

This reformulation of MDRP is critical, because it is the first step in allowing us to approach the problem by looking at the next-hops and distances obtained at each router for each destination. Gallager described a distributed routing algorithm for solving the above five equations. When the algorithm converges, the aggregate of the successor sets for a given destination j(Sⱼⁱ for every i) define a directed acyclic graph. In fact, in any implementation, Sⱼⁱ must be loop-free at every instant, because even temporary loops cause traffic to recirculate at some nodes and result in incorrect marginal delay computations, which in turn can prevent the algorithm from converging or obtaining minimum delays.

Gallager's distributed algorithm uses an interesting blocking technique to provide loop-freedom at every instant. This algorithm is herein referred to as OPT. Unfortunately, OPT cannot be used in real networks for several reasons. A major drawback of OPT is that a global step size η needs to be chosen and every router must use it to ensure convergence. Because η depends on the input traffic pattern, it is not possible to determine one in practice that works for all input patterns and for all possible topology modifications. The routing parameters are directly computed by OPT and the multiple loop-free paths are simply implied by the routing parameters in Eq. (9). The computation of routing parameters is a destination-controlled process, and as such as considered to be a very slow process. The destination initiates every iteration that adjusts the routing parameters at every router; furthermore, each iteration takes a time proportional to the diameter of the network and number of messages proportional to number of links. This renders the algorithm slow to converge and useful only when traffic and topology are stationary for times long enough for all routers to adjust their routing parameters between changes. Also, depending on the global constant η, the destination must initiate several iterations for the parameters to converge to their final values. The number of such iterations needed for convergence tends to be large for a small η, and small for a large value of η. Unfortunately, η cannot be made arbitrarily large to reduce the number of iterations and to speed up convergence, because the algorithm may not converge at all for large values of η.

It will be appreciated, therefore, that the Gallager algorithm is limited to obtaining lower bounds under stationary traffic conditions, and therefore it is not suitable for use in practical networks. Several algorithms have been proposed for improving the minimum-delay routing algorithm of Gallager, such as by extending it to handle topological changes, improving techniques to measure marginal delays, speeding up convergence with second derivatives. It will be appreciated, however, that all of the algorithms still depend on global constants and require that the network traffic be static or quasi-static.

Because of its oscillatory behavior when link costs are related to delays, attempts to improve shortest-path routing have been mainly restricted to using better link-cost metrics or using multiple-paths. To avoid undetected loops, OSPF permits multiple paths to a destination only when they have the same length. More recently, algorithms has been proposed based on distance vectors that support multiple paths of unequal costs to each destination; however, link costs are not tied to delays. One approach addresses the drawbacks of the shortest-path first (SPF) algorithm by using alternate paths to detour traffic around points of congestion or network failures. However, the alternate paths in SPF-EE (for emergency exits) are computed on a reactive basis, such as after congestion occurs, which is less effective m dealing with short bursts of traffic.

Another algorithm has been described for minimizing delays, however, this algorithm requires that the routing-table updates at all the routers be synchronized to prevent looping, which increases end-to-end delays. Because the synchronization intervals required by this algorithm must be known by all routers, this is akin to using a global constant as in Gallager's algorithm. This approach is not scalable to very large networks, because the time needed for routing-table update synchronization becomes large, and this in turn limits its responsiveness to short-term traffic fluctuations. What is seriously lacking in this algorithm is a technique for asynchronous computation of multiple paths with instantaneous loop-freedom.

### BRIEF SUMMARY OF THE INVENTION

In general terms, the invention is a practical framework and method for approximating minimum delay routing that can be implemented in practical networks. The components of the framework and method comprise a multi-path loop-free link state routing algorithm, and a set of novel heuristics for load-balancing traffic on multiple next-hops. The method is generally performed by (a) determining multiple loop-free paths of unequal cost to a destination in response to long-term link-cost information, and (b) allocating flows to those destinations along the multiple loop-free paths by adjusting routing parameters available at each router in response to short-term link-cost information.

The framework presented allows for “near-optimal” routing with delays comparable to those of optimal routing and that is as flexible and responsive as single-path routing protocols proposed to date. First, an approximation to the Gallager's minimum-delay routing problem is derived, and then algorithms that implement the approximation scheme are presented and verified. Introduced in the method are a routing algorithm that is based on link-state information which provides multiple loop-free paths of unequal cost to each destination at every instant. The traffic delays exhibited within the present framework are comparable to those obtained using the Gallager minimum-delay routing algorithm. Also, the present framework is shown to exhibit substantially smaller delays, while utilizing resources more effectively than traditional single-path routing.

An object of the invention is to provide a routing framework in which multiple loop-free routing paths may be determined within a computer network subject to bursty traffic and network topology changes.

Another object of the invention is to provide a method which can rapidly approximate solutions to the minimum-delay routing problem (MDRP) within a dynamic computer network subject to bursty traffic and topology changes.

Another object of the invention is to provide a routing method that determines “near-optimal” routing paths, with delays close to those attainable using the Gallager method.

Another object of the invention is to provide a method of generalizing the sufficient conditions necessary to assure loop-free routing, so that these may be utilized on any type of routing algorithm.

Another object of the invention is to provide a routing algorithm that is based on link-state information on multiple paths of unequal costs to the destination.

Another object of the invention is to provide a routing method in which the routing algorithms converge rapidly.

Another object of the invention is to provide multi-path routing method that is as fast as the single-path routing algorithms currently in use.

Another object of the invention is to provide a multi-path routing method that is as flexible and responsive as single-path routing protocols.

Another object of the invention is to provide a multi-path routing method that can respond quickly to temporary traffic bursts using local short-term metrics.

Another object of the invention is to eliminate routing path oscillations.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a listing of a pseudocode procedure INIT-PDA according to an aspect of the present invention, showing initialization of the router when power is applied.

FIG. 2 is a listing of a pseudocode procedure NTU according to an aspect of the present invention, showing neighbor topology table update procedure.

FIG. 3 is a listing of a pseudocode procedure MTU according to an aspect of the present invention, showing main topology table update procedure.

FIG. 4 is a listing of a pseudocode procedure MPDA according to an aspect of the present invention, showing multiple-path partial-topology dissemination procedure.

FIG. 5 is a graph of active-passive phase transitions within MPDA according to an aspect of the present invention.

FIG. 6 is a listing of a pseudocode procedure IH according to an aspect of the present invention, showing a heuristic for determining an initial load assignment.

FIG. 7 is a listing of a pseudocode procedure AH according to an aspect of the present invention, showing a heuristic for performing an incremental load adjustment.

FIG. 8 is a graph of the CAIRN topology as utilized in simulations of the present invention.

FIG. 9 is a graph of the NET1 topology as utilized in simulations of the present invention.

FIG. 10 is a graph comparing simulated delays in MP and OPT within CAIRN.

FIG. 11 is a graph comparing simulated delays in MP and OPT within NET1.

FIG. 12 is a graph comparing simulated delays in MP and SP within CAIRN.

FIG. 13 is a graph comparing simulated delays in MP and SP within NET1.

FIG. 14 is a graph comparing simulated delays in MP and SP within CAIRN, when Tₛ is kept constant and Tₗ is increased.

FIG. 15 is a graph comparing simulated delays in MP and SP within NET1, when Tₛ is kept constant and Tₗ is increased.

FIG. 16 is a graph of average delay using OPT and MP routing, showing the response to a step change in flow.

FIG. 17 is a graph of a variable traffic flow utilized within the simulations, showing a variable traffic input pattern with respect to time.

FIG. 18 is a graph comparing simulated average delays for OPT, MP, and SP routing, shown in response to the variable traffic depicted in FIG. 17, within CAIRN.

FIG. 19 is a graph comparing simulated average delays for MP and SP routing, shown in response to internet traffic within CAIRN.

### DETAILED DESCRIPTION OF THE INVENTION

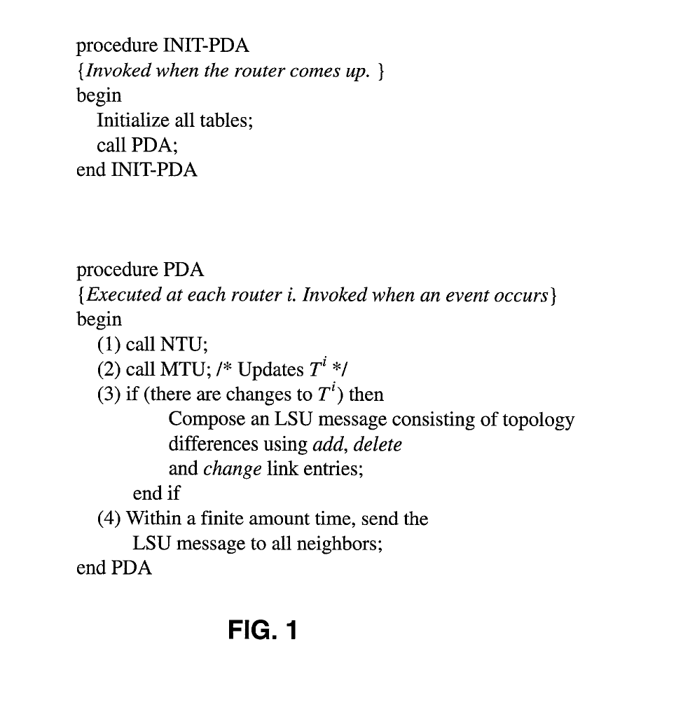

Referring more specifically to the drawings, for illustrative purposes the present invention is described with reference to FIG. 1 through FIG. 19. It will be appreciated that implementation the invention may vary, however, without departing from the inventive concepts as disclosed herein.

1. Introduction

The present invention provides a method for approximating solutions to MDRP that are compatible for use within operational networks with dynamic traffic. In general terms, the method can be considered to partition the computation of minimum-delay paths into two parts. First, multiple loop-free paths of unequal cost to a destination are established using long-term link-cost information. This is followed by the allocation of flows to destinations along the multiple loop-free paths available at each router; such an allocation is based on heuristics that attempt to minimize delays using short-term link-cost information. The heuristics are implemented within programming that is executed by the router. It is this partitioning of MDRP that permits us to implement routing algorithms that provide routers with near-optimum delays while keeping the routing algorithm as responsive to traffic or topology changes as the best of today's shortest-path routing algorithms. A set of invariants is also presented that permits Gallager's necessary and sufficient conditions for minimum-delay routing to be approximated with loop-free routing conditions achievable with simple distributed routing algorithms that do not require any global variables or global synchronization. Therefore, the present invention adapts the theories of Gallager for use within practical networks.

2. A New Framework for Minimum-Delay Routing

It was noted that in Gallager's algorithm, the computation of the routing parameter set φ is slow to converge and works only in the case of stationary or quasi-stationary traffic. Traffic on the Internet, however, is hardly stationary and perfect load balancing is neither possible nor necessary. It will be appreciated intuitively, that an approximate load balancing scheme based on some heuristic which can quickly adapt to dynamic traffic should be sufficient to minimize delays substantially.

The key idea in the approach of the present invention is to substantially reverse the way in which Gallager's algorithm solves MDRP. The intuition behind our approach is that establishing paths from sources to destinations requires significantly more time than shifting loads from one set of neighbors to another, simply because of the propagation and processing delays incurred along the paths. Accordingly, it makes sense to first determine multiple loop-free paths using long-term (end-to-end) delay information, and then adjust routing parameters along the predefined multiple paths using short-term (local) delay information.

The approach of the present invention allows utilizes distributed algorithms to compute multiple loop-free paths from source to destination that in many cases are as fast as single-path routing algorithms currently in use, and local heuristics that can respond quickly to temporary traffic bursts using local short-term metrics alone. Therefore, Eq. (8) through Eq. (12) derived in Gallager's method are mapped into the following three equations.

Dⱼⁱ=min{Dⱼ^{k}+lₖⁱ|kεNⁱ} (13)

Sⱼⁱ={k|Dⱼ^{k}<DⱼⁱΛkεNⁱ} (14)

φⱼₖⁱ=ψ(k,Aⱼⁱ,Bⱼⁱ) kεNⁱ (15)

where Aⱼⁱ={Dⱼ^{p}+lₚⁱ|pεNⁱ} and Bⱼⁱ={φⱼₚⁱ|pεNⁱ}.

These equations simply state that, for an algorithm to approximate minimum-delay routing, it must establish loop-free paths and use a function ψ to allocate flows over those paths. It should be observed that Eq. (13) is the well-known Bellman-Ford (BF) equation for computing the shortest paths, and Eq. (14) is the successor set consisting of the neighbors that are closer to the destination than the router itself. It should be noted that the paths implied by the neighbors in the successor set of a router need not be of the same length. The function ψ in Eq. (15) is a heuristic function that determines the routing parameters. Because changing the routing parameters effects the marginal delay of the links, and therefore the link-costs, regular updates of the link costs are utilized.

The main problem with attempting to solve MDRP using Eq. (13) through Eq. (15) directly is that these equations assume that routing information is consistent throughout the network. In practice, a node (router) must choose its distance and successor set using routing information obtained through its neighbors, and this information may be outdated. At any time t, for a particular destination j, the successor sets of all nodes define a routing graph SGⱼ(t)={(m,n)|nεSⱼ^{m}(t), mεN}. In single-path routing, Sⱼⁱ(t) has at most one neighbor; the neighbor that is on the shortest path to destination j. Accordingly, SGⱼ(t) for single-path routing is a link-tree rooted at j if loops are never created. The routing graph SGⱼ(t) in our case should be a directed acyclic graph in order for minimum delays to be approached.

The blocking technique used in Gallager's algorithm ensures instantaneous loop-freedom. Likewise, to provide loop-free paths even when the network is in a transient state within the context of our framework, additional constraints must be imposed on the choice of successors at each router, which essentially must preclude the use of neighbors that may lead to looping.

Several algorithms have been proposed in the past to provide loop-free paths at every instant for the case of single-path routing, such as the Jaffe-Moss algorithm, DUAL, LPA, and the Merlin-Segall algorithm, while one algorithm, DASM, has been proposed for the case of multiple paths per destination. These algorithms are based on the exchange of vectors of distances, together with some form of coordination among routers spanning one or multiple hops. The coordination among routers determines when the routers can update their routing tables. This coordination is in turn guided by local conditions that depend on values of reported distances to destinations which are sufficient to prevent loops from occurring.

The following is a method to generalize loop-free routing over single paths or multiple paths by means of the following loop-free invariant (LFI) which is applicable to any type of routing algorithm. The same terminology and nomenclature is adopted that in was introduced for DUAL to describe the LFI conditions.

Loop-free Invariant (LFI) Conditions

Any routing algorithm designed such that the following two equations are always satisfied, automatically provides loop-free paths at every instant, regardless of the type of routing algorithm being used:

FDⱼⁱ≦Dⱼ^{k} kεNⁱ (16)

Sⱼⁱ={k|Dⱼₖⁱ<FDⱼⁱΛkεNⁱ} (17)

where Dⱼₖⁱ is the value of Dⱼ^{k} reported to i by its neighbors k; and FDⱼⁱ is called the “feasible distance” of router i for destination j, and is an estimate of Dⱼⁱ, in the sense that FDⱼⁱ equals Dⱼⁱ in steady state but is allowed to differ from it temporarily during periods of network transitions.

In link-state algorithms, the values of Dⱼₖⁱ are determined locally from the link-state information supplied by the router's neighbors; in contrast, in distance-vector algorithms, the distances are directly communicated among neighbors. The following theorem verifies this key result of the present method.

Theorem 1

If the LFI conditions are satisfied at any time t the routing graph SGⱼ(t) implied by the successor set Sⱼⁱ(t) is loop-free.

Proof: Let kεSⱼⁱ(t) then from Eq. (17) we have:

Dⱼₖⁱ(t)<FDⱼⁱ(t) (18)

At router k, because router i is a neighbor, from Eq. (16) we have FDⱼ^{k}(t)≦Dⱼₖⁱ(t). Combining this result with Eq. (18) we obtain:

FDⱼ^{k}(t)<FDⱼⁱ(t) (19)

It will be appreciated that Eq. (19) states that, if k is a successor of router i in a path to destination j, then the feasibility distance of k to j is strictly less than the feasible distance of router i to j. Now, if the successor sets define a loop at time t with respect to j, then for some router p on the loop, we arrive at FDⱼ^{p}(t)<FDⱼ^{p}(t), which is obviously an absurd relation. Therefore, the LFI conditions are sufficient for loop-freedom D.

With the result of Theorem 1, Eq. (14) can be approximated with the LFI conditions to render a routing approach that does not require routing information to be globally consistent, at the expense of rendering delays that may be longer than optimal.

Accordingly, our framework for near-optimum-delay routing lies in finding the solution to the following equations using a distributed algorithm:

Dⱼⁱ=min{Dⱼ^{k}+lₖⁱ|kεNⁱ} (20)

FDⱼⁱ≦Dⱼᵢ^{k} kεNⁱ (21)

Sⱼⁱ={k|Dⱼₖⁱ<FDⱼⁱΛkεNⁱ} (22)

φⱼₖⁱ=ψ(k,{Dⱼ^{p}+lₚⁱ|pεNⁱ}, {φⱼₚⁱ|pεNⁱ}) kεNⁱ (23)

3. Implementing Near-Optimum-Delay Routing

The following describes a routing algorithm based on this new routing framework. The algorithm consists of two key components: (a) the first link-state routing algorithm that provides multiple loop-free paths of arbitrary positive cost at every instant, and (b) flow allocation heuristics that approximate minimum delays along the predefined multiple loop-free paths available for each destination.

The approach is based on link-state information, rather than distance information, because extending our results to minimum-delay routing with additional constraints can be done more efficiently by working with link parameters than with path parameters, which are the combination of link parameters. The present approach generally consists of three components: computing multiple loop-free paths between sources and destinations, distributing traffic over such paths, and computing link costs to optimize local traffic flow. Wherein the path is computed with long-term routing information and optimized within the local traffic flow in response to short-term link-cost information which modifies the routing parameters.

3.1 Computing Multiple Loop-free Paths

The computation of multiple loop-free paths is described in two parts: computing Dⱼⁱ using a shortest-path algorithm based on link-state information, and computing Sⱼⁱ by extending that algorithm to support multiple successors along loop-free paths to each destination.

3.1.1 Computing Dⱼⁱ

A number of distributed algorithms exist for computing shortest paths, and any of these may be extended to provide multiple paths of equal and unequal costs as the extension obeys the LFI introduced in the previous section.

The partial-topology dissemination algorithm (PDA) propagates enough link-state information in the network, to assure that each router has sufficient link-state information to compute shortest paths to every destination. In this respect, PDA is similar to other link-state algorithms, such as OSPF, SPTA, LVA, and ALP. An attempt has been made to combine the best features found in LVA, ALP and SPTA into PDA. As in LVA and ALP, a router communicates information to its neighbors regarding only those links that are part of its minimum-cost routing tree, and in similar manner to SPTA, a router validates link information based on distances to heads of links and not on sequence numbers.

It is assumed within PDA that a router detects the failure, recovery, and link-cost change of an adjacent link within a finite amount of time. An underlying protocol ensures that messages transmitted over an operational link are received correctly and in the proper sequence within a finite time and are processed by the router one at a time in the order received. These are the same assumptions made for similar routing algorithms and can be easily satisfied in practice. Each router i running PDA maintains the following information:

1. The main topology table, Tⁱ stores the characteristics of each link known to router i. Each entry in Tⁱ is a triplet [h,t,d] where h is the head, t is the tail and d is the cost of the link h→t.

2. The neighbor topology table, Tₖⁱ, is associated with each neighbor k. The table stores the link-state information communicated by the neighbor k. That is, Tₖⁱ is a time-delayed version of T^{k}.

3. The distance table stores the distances from router i to each destination based on the topology in Tⁱ and the distances from each neighbor k to each destination based on the topologies in Tₖⁱ for each k. The distance from router i to node j in Tⁱ is denoted by Dⱼⁱ; the distance from k to j in Tₖⁱ is denoted by Dⱼₖⁱ.

4. The routing table stores, for each destination j, the successor set Sⱼⁱ and the feasible distance FDⱼⁱ, which is used by MPDA to enforce LFI conditions.

The link tables stores, for each neighbor k, the cost lₖⁱ of the adjacent link to the neighbor.

The unit of information exchanged between routers is a link-state update (LSU) message. A router sends an LSU message containing one or more entries, with each entry specifying addition, deletion, or change in cost of a link in the router's main topology table Tⁱ. Each entry of an LSU consists of link information in the form of a triplet [h,t,d] where h is the head, t is the tail, and d is the cost of the link h→t. The LSU message contains an acknowledgement (ACK) flag for acknowledging the receipt of an LSU message from a neighbor, which is utilized only by MPDA.

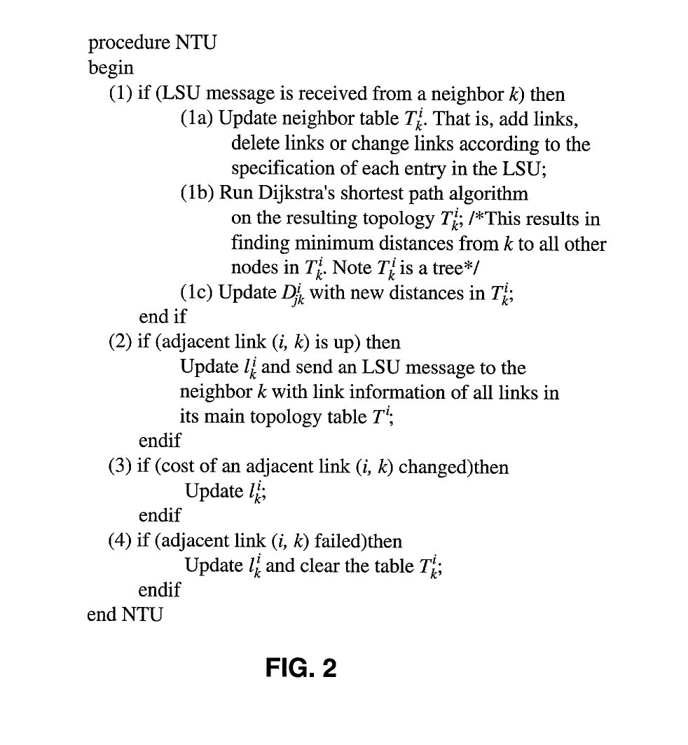

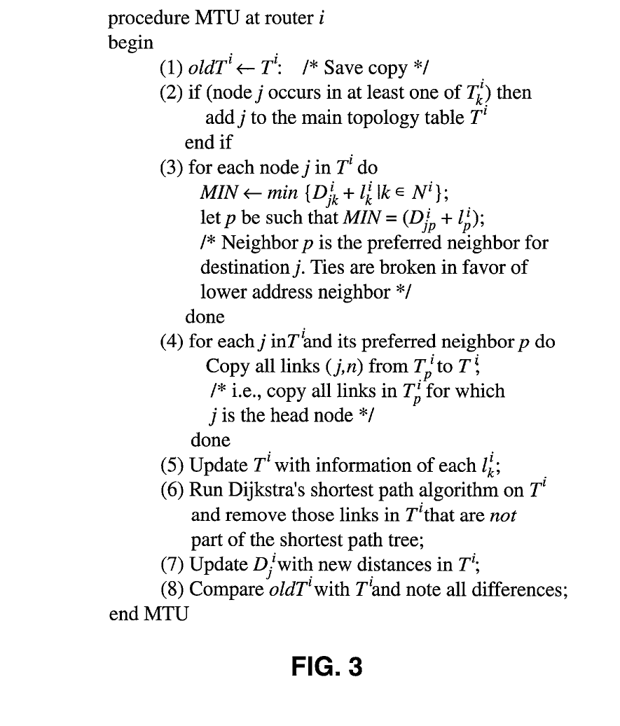

FIG. 1 depicts an INIT-PDA procedure that initializes the tables of a router at startup time; all variables of type distance are initialized to infinity and those of type node are initialized to null. All successor sets are initialized to the empty set. PDA is executed each time an event occurs; an event can be either a receipt of an LSU message from a neighbor or the detection of an adjacent link-cost change. FIG. 2 depicts a procedure NTU (neighbor topology table update) which processes the received message and updates the necessary tables. FIG. 3 depicts the procedure MTU which constructs the shortest path tree for a given router from the topologies reported by its neighbors. The new shortest-path tree obtained is compared with the previous version to determine the differences. It is only the differences that are reported to the neighbors. The router then waits for the next event and, when it occurs, the whole process is repeated.

The algorithm MTU at router i merges the topologies Tₖⁱ and the adjacent links lₖⁱ to obtain Tⁱ. The merge process proceeds if all neighbor topologies contain disjoint sets of links, but when two or more neighbors report conflicting information regarding a particular link, the conflict has to be resolved. Sequence numbers may be used to distinguish between old and new link information as in OSPF, but PDA resolves the conflict as follows. If two or more neighbors report information of link (m,n) then the router i should update topology table Tⁱ with link information by the neighbor that offers the shortest distance from the router i to the head node m of the link. Ties are broken in favor of the neighbor with the lowest address. For adjacent links, router i itself is the head of the link and thus has the shortest distance. Therefore, any information about an adjacent link supplied by neighbors will be overridden by the most current information about the link available to router i. Dijkstra's shortest path algorithm is run on Tⁱ and only the links that constitute the shortest-path tree are retained. It should be notes that since many potentially shortest-path trees exist, ties should be broken consistently during the run of Dijkstra's algorithm.

The following illustrates the correct operation of PDA based on considering that the topology tables at all nodes converge to the shortest paths within a finite time after the last link-cost change in the network. Because there are no more changes to the topology tables after convergence is completed, no more LSU messages are generated.

First, a few definitions should be appreciated before proceeding. The n-hop minimum distance of router i to node j within a network is the minimum distance possible using a path of n links or less. A path that offers the n-hop minimum distance is called an n-hop minimum path. If no path exists with n-hops or less, from router i to j, then the n-hop minimum distance from i to j is undefined. An n-hop minimum tree of a node i is a tree in which router i is the root and all paths of n hops or less from the root to any other node is an n-hop minimum path. It should be appreciated that more than one n-hop minimum tree may exist.

Let G denote the final topology of the network after all link changes have occurred, as registered by an omniscient observer; bold font is employed to refer to all quantities in G. Let Hₙⁱ denote an n-hop minimum tree rooted at router i in G and let Mₙⁱ be the set of nodes that are within n hops from i in Hₙⁱ. Let dᵢⱼ denote the distance of i to j in Hₙⁱ. Let dᵢⱼ be the cost of the link i→j. The notation i [symbol] j represents a path from i to j of zero or more links.

Property 2

The principle of optimality states that a sub-path of a shortest path between two nodes is also a shortest path between the end nodes of the subpath. From the principle of optimality: if H and H′ are two n-hop minimum trees rooted at router i, while M and M′ are sets of nodes that are within n hops from i in H and H′ respectively, then M=M′=Mₙⁱ. Also for each jεMₙⁱ the length of path i [symbol] j in both H and H′ is equal to Dₙ^{ij}; and Dₕ^{ij}≦Dₙ^{ij} if h≧n.

A router i is said to know at least the n-hop minimum tree, if the tree represented by its main topology table Tⁱ is at least an n-hop minimum tree rooted at i in G and there exist at least n nodes in Tⁱ that are reachable from the root i. Note that the links in Tⁱ that exceed n-hops may have costs that do not agree with the link costs in G.

Lemma 1

If a router i has the final correct costs of the adjacent links and for each neighbor k the topology Tₖⁱ is an n-hop minimum tree, then the topology Tⁱ is an (n+1)-hop after the execution of MTU.

Proof: Let Aⁱ=∪ [symbol] Aₖⁱ where Aₖⁱ is the set of nodes in Tₖⁱ. Since Tₖⁱ is at least a (n−1)-hop minimum tree and node i can appear at most once in each of Aₖⁱ, each Aₖⁱ has at least n−1 unique elements. Therefore, Aⁱ has at least n−1 elements.

Let Mₙⁱ be the set of (n−1) nearest elements to node i in Aⁱ. That is Mₙⁱ [symbol] Aⁱ and |Mₙⁱ|=n−1 and for each jεMₙⁱ and νεAₙⁱ−Mₙⁱ, min{Dⱼₖⁱ+lₖⁱ|kεNⁱ}≦min{D_{νk}ⁱ+lₖⁱ|kεNⁱ}. The theorem is proven in the following two parts:

1. Let Gₙⁱ represent the graph constructed by MTU on line 4 and 5. (i.e. before applying Dijkstra on line 6). For each jεMₙⁱ there is a path i [symbol] j in Gₙⁱ such that its length is at most Dₙ^{ij}.

2. After running Dijkstra on Gₙⁱ on line 6 in MTU, the resulting tree is at least an n-hop minimum tree.

Let us first assume Part 1 is true and prove Part 2, and then proceed to prove Part 1. From the statement in Part 1, for each node jεMₙⁱ there is a path i [symbol] j in Gₙⁱ with length at most Dₙ^{ij}. After running Dijkstra's algorithm, in the resulting graph, we can infer that there is a path i [symbol] j with length at most Dₙ^{ij}. Because there are n−1 nodes in Mₙⁱ, the tree constructed has at least n nodes with node i included. Accordingly, it follows from Property 1 that the tree constructed is at least an n-hop minimum tree.

Now the Proof proceeds for Part 1. Order the nodes in Mₙⁱ in non-decreasing order. The proof is by induction on the sequence of elements in Mₙⁱ as they are added to Gₙⁱ. The base case is when Gₙⁱ contains just one link lₘ₁ⁱ=min{lₖⁱ|kεNⁱ} and m₁ is the first element of Mⁱ and lₘ₁ⁱ=D₁^{i,m1}. Let the statement hold for the first m−1 elements of Mₙⁱ and consider the m-th element jεMₙⁱ. Let K be the highest priority neighbor for which Dⱼₖⁱ+lₖⁱ=min{Dⱼₖⁱ+lₖⁱ|kεNⁱ}. At most m−2 nodes in Tₖⁱ can have a smaller or equal distance than j, which implies that path K [symbol] j exists with at most m−1 hops. Let ν be the neighbor of j in Tₖⁱ. Then the path K [symbol] ν→j has at most m−1 hops. Since Tₖⁱ is at least a (n−1)-hop minimum tree, the cost of link ν→j must agree with G. And because D_{νK}ⁱ+l_{K}ⁱ<D_{jK}ⁱ+l_{K}ⁱ, from our inductive hypothesis, there is a path i [symbol] ν in Gₙⁱ such that the length is at most Dₙ^{i,ν}.

The preferred neighbor for ν is also K, so that the link ν→j will be included in the construction of Gₙⁱ. If some other neighbor K′ instead of K is the preferred neighbor for ν, then one of the following cases should have occurred: (a) D_{νK′}ⁱ+l_{K′}ⁱ<D_{νK}ⁱ+l_{K}ⁱ or (b) D_{νK′}ⁱ+l_{K′}ⁱ=D_{νK}ⁱ+l_{K}ⁱ and priority of K′ is greater than priority of K.

Case (a): If D_{νK′}ⁱ+l_{K′}ⁱ<D_{νK}ⁱ+l_{K}ⁱ, then given that D_{νK}ⁱ+l_{K}ⁱ≦D_{jK′}ⁱ+l_{K′}ⁱ, it follows that the path ν [symbol] j in T_{K′}ⁱ, is greater than the cost ν→j in G which implies that T_{K′}ⁱ is not a (n−1)-hop minimum tree, which would of course contradict our assumption. Therefore, D_{νK}ⁱ+l_{K}ⁱ=min{D_{νk}^{i+l}ₖⁱ|kεNⁱ}.

Case (b): Let Qⱼ be the set of neighbors that give the minimum distance to j, such as for each kεQⱼ, Dⱼₖⁱ+lₖⁱ=min{Dⱼₖⁱ+lₖⁱ|kεNⁱ}. Similarly, let Q_{ν} be such that for each kεQ_{ν}, D_{νk}ⁱ+lₖⁱ=min{D_{νk}ⁱ+lₖⁱ|kεNⁱ}. If kεQ_{ν} and k∉Qⱼ then it follows from the same argument used in case (a) that ν [symbol] j in Tₖⁱ is greater than ν→j in G, which implies that Tₖⁱ is not an (n−1)-hop minimum tree, which would also contradict the assumption. Therefore, Q_{ν} [symbol] Qⱼ. Also from the same argument used in case (a) above it can be inferred that KεQ₈₄ . Because K has the highest priority amongst all members of Qⱼ and Q_{ν} [symbol] Qⱼ, and because kεQ₈₄ , K must also have the highest priority among all members of Q_{ν}. This proves that ν→j will be included in the construction of Gₙⁱ. Because Dₙ^{i,ν}+d_{νj}=Dₙ^{i,j} in G where d_{νj} is the final cost of link ν→j, and the length of ν [symbol] j in Gₙⁱ is less than Dₙ^{i,ν} from our inductive hypothesis, we obtained that the length of i [symbol] j in Gₙⁱ is less than Dₙ^{i,j}, which proves the first part of the theorem.

Theorem 2

At each router i, the main topology Tⁱ gives the correct shortest paths to all known destinations a finite time after the last change in the network.

Proof: The proof is by induction on tₙ, the global time when for each router i, Tⁱ is at least n-hop minimum tree. Because the longest loop-free path in the network has at most N−1 links where N is the number of nodes in the network, t_{N-1} is the time when every router has the shortest path to every other node. We need therefore to show that t_{N-1} is finite. The base case is t₁, the time when every node has 1-hop minimum distance and because the adjacent link changes are notified within finite time, t₁<∞. Let tₙ<∞ for some n<N. Given that the propagation delays are finite, each router will have each of its neighbors n-hop minimum tree in finite time after tₙ. From Theorem 1 it can be seen that the router will have at least the (n+1)-hop minimum tree within a finite time after tₙ. Therefore, tₙ₊₁<∞. From induction it can be concluded that t_{N-1}<∞.

3.1.2 Computing Sⱼⁱ

The LFI conditions introduced previously suggest a technique for computing Sⱼⁱ such that the implied routing graph SGⱼ is loop-free at every instant. To determine FDⱼⁱ in Eq. (16), router i needs to know Dⱼᵢ^{k}, the distance from i to node j in the topology table Tᵢ^{k}. Because of propagation delays, there may be discrepancies between the main topology table Tⁱ at router i and its copy Tᵢ^{k} at the neighbor k. However, at time t, the topology table Tᵢ^{k} is a copy of the main topology table Tⁱ at some earlier time t′<t. Logically, if a copy of Dⱼⁱ is saved each time an LSU is sent, a feasible distance FDⱼⁱ that satisfies the LFI conditions can be found in the history of values of Dⱼⁱ that have been saved.

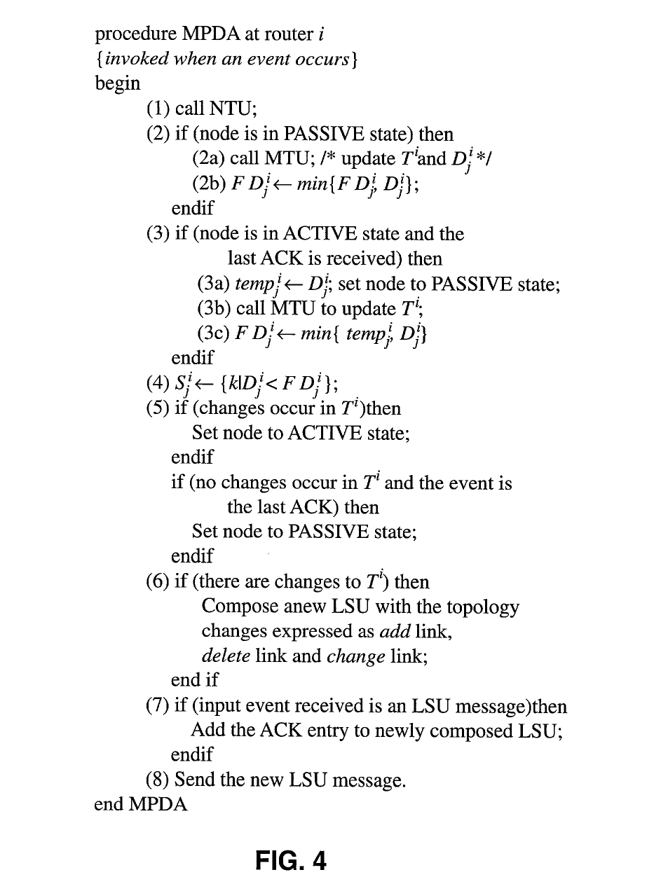

The multiple-path partial topology dissemination algorithm, or MPDA. shown in FIG. 4 is a modification of PDA that enforces the LFI conditions by synchronizing the exchange of LSUs between neighbors. In MPDA, each LSU sent by a router is acknowledged by all its neighbors before router sends the next LSU. The inter-neighbor synchronization used in MPDA spans only a single hop, unlike the synchronization in diffusing computations which potentially span the entire network. A router is said to be in an ACTIVE state when it is waiting for its neighbors to acknowledge the LSU message it sent; otherwise it is in a PASSIVE state.

Assume that, initially, all routers are in a PASSIVE state with all routers having the correct distances to all destinations. Then a series of link-cost changes occurs in the network resulting in some or all routers going through a sequence of PASSIVE-to-ACTIVE and ACTIVE-to-PASSIVE state transitions, until all routers become PASSIVE with correct distances to the destinations.

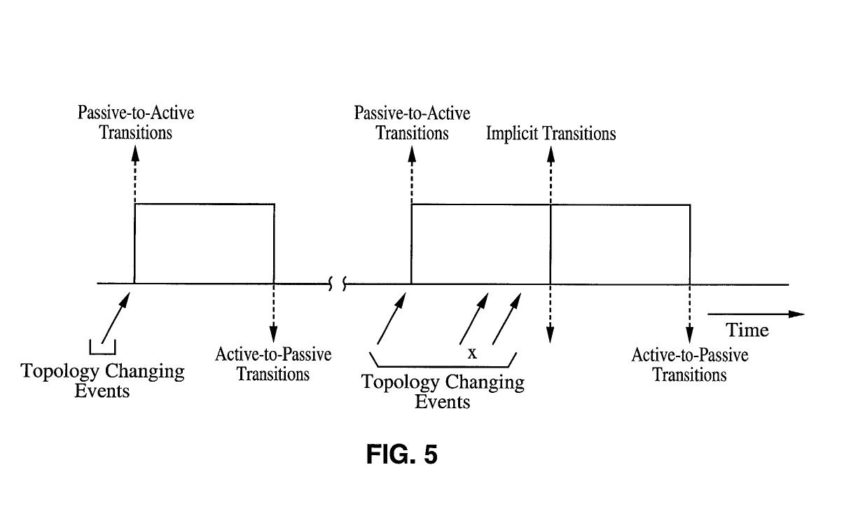

If a router in a PASSIVE state receives an event that does not change its topology Tⁱ, then the router has nothing to report and remains in the PASSIVE state. However, if a router in PASSIVE state receives an event that affects a change in its topology, the router sends those changes to its neighbors, and goes into ACTIVE state awaiting ACKs from its neighbors. Events that occur during the ACTIVE period are processed to update Tᵢ^{k} and lᵢ^{k}, but not Tⁱ; the updating of Tⁱ by MTU is deferred until the end of the ACTIVE phase. At the end of the ACTIVE phase, when ACKs from all neighbors are received, router i updates Tⁱ with changes that may have occurred in Tₖⁱ due to events received during the ACTIVE phase. If no changes occurred in Tⁱ that need reporting, then the router becomes PASSIVE; otherwise, as shown in FIG. 5, there are changes in Tⁱ that may have resulted due to events, and the neighbors need to be notified. This results in a new LSU, and the router immediately becoming ACTIVE again. In this case, there is an implicit PASSIVE period, of zero time length, between two back-to-back ACTIVE periods, as illustrated in FIG. 5. A router i receiving an LSU message from k must send back an LSU with the ACK bit set after updating Tₖⁱ. If the router does not have any updates to send, either because it is in ACTIVE state or because it does not have any changes to report, it sends back an empty LSU with just the ACK flag set. When a router detects that an adjacent link failed, any pending ACKs from the neighbor at the other end of the link are treated as received. As a result of all LSUs being acknowledged within a finite time, no deadlocks can occur.

The following theorem proves that MPDA theoretically provides loop-free multi-paths at every instant.

Theorem 3 Safety Property

At any time t, the directed graph SGⱼ(t) implied by the successor sets Sⱼⁱ(t) computed by MPDA at each router is loop-free.

Proof: Let tₙ be the time when FDⱼⁱ is updated for the n-th time. The proof is by induction in the time intervals [tₙ,tₙ₊₁]. As an inductive hypothesis, assume that:

FDⱼⁱ(t)≦Dⱼᵢ^{k}(t) kεNⁱ, t<tₙ (24)

it has been shown that

FDⱼⁱ(t)≦Dⱼᵢ^{k}(t) tε[tₙ, tₙ₊₁] (25)

From the description of MPDA in FIG. 4 it is observed that when FDⱼⁱ is updated at lines 2b and 3c, Dⱼⁱ is also updated at lines 2a and 3b respectively. It is also observed that FDⱼⁱ is updated only during state transitions, and regardless of whether the transition was from PASSIVE-to-ACTIVE or from ACTIVE-to-PASSIVE, Eq. (26) below holds true. Note that there is an implicit PASSIVE state between two back-to-back ACTIVE states.

FDⱼⁱ(tₙ)≦min{Dⱼⁱ(tₙ₋₁),Dⱼⁱ(tₙ)} (26)

Let t′ be the time when the LSU sent by i at tₙ is received and processed by neighbor k. Because of the non-zero propagation delay across any link, t′ is such that tₙ<t′<tₙ₊₁. So that

Dⱼᵢ^{k}(t′)≦Dⱼⁱ(tₙ) (27)

Because FDⱼⁱ is modified at tₙ and then remains unchanged within (tₙ,tₙ₊₁), we obtain from Eq. (24) that

FDⱼⁱ(t)≦Dⱼᵢ^{k}(t) tε[tₙ,t′] (28)

From Eq. (26) and Eq. (27) the following is obtained

FDⱼⁱ(t)≦Dⱼᵢ^{k}(t) tε[t′,tₙ₊₁] (29)

From Eq. (28) and Eq. (29)

FDⱼⁱ(t)≦Dⱼᵢ^{k}(t) tε[tₙ,tₙ₊₁] (30)

At tₙ₊₁, again from the design of MPDA

FDⱼⁱ(tₙ₊₁)≦min{Dⱼⁱ(tₙ),Dⱼⁱ(tₙ₊₁)} (31)

Also, because propagation delays are positive, node k at tₙ₊₁ cannot yet have the value Dⱼⁱ(tₙ₊₁). So, we have

Dⱼᵢ^{k}(tₙ₊₁)=Dⱼⁱ(tₙ) (32)

Combining Eq. (32) and Eq. (31) for time tₙ₊₁, we arrive at

FDⱼⁱ(tₙ₊₁)≦Dⱼᵢ^{k}(tₙ₊₁) (33)

and Eq. (25) follows from combining Eq. (30) and Eq. (33).

Because FDⱼⁱ(t₀)≦Dⱼᵢ^{k}(t₀) at initialization, from induction we have that FDⱼⁱ(t)≦Dⱼᵢ^{k}(t) for all t. Given that that successor sets are computed based on FDⱼⁱ, it follows that the LFI conditions are always satisfied. According to Theorem 1, this implies that the successor graph SGⱼ is always loop-free.

Theorem 4 Liveness Property

A finite time after the last change in the network, Dⱼⁱ gives the correct shortest distance and

Sⱼⁱ={k|Dⱼ^{k}<Dⱼⁱ, kεNⁱ} at each router i

Proof: The convergence of MPDA follows directly from the convergence of PDA, because the update messages in MPDA are only delayed by a finite time as allowed in the fourth line of the PDA algorithm. Therefore, the distances Dⱼⁱ in MPDA also converge to shortest distances. Because changes to Tⁱ are always reported to the neighbors, and subsequently incorporated by the neighbors in their tables within a finite time, Dⱼₖⁱ=Dⱼ^{k} for kεNⁱ after convergence. From line 3c in MPDA, we observe that when router i becomes PASSIVE, and FDⱼⁱ=Dⱼⁱ holds true. Because all routers are PASSIVE at convergence time it follows that the set {k|Dⱼₖⁱ<FDⱼⁱ, kεNⁱ} is the same as the set {k|Dⱼ^{k}<Dⱼⁱ, kεNⁱ}.

3.2 Distributing Traffic over Multiple Paths

In general, the function ψ can be any function that satisfies Property 1, but our objective is to obtain a function ψ that performs load balancing that is as close as possible to perfect load balancing, as described in Eq. (10) through Eq.(12).

The function ψ should also be suitable for use in dynamic networks, where the flows over links are continuously causing continuous link-cost changes. To respond to these queuing delays at the links must be measured periodically and routing paths must be recomputed. However, recomputing of routing paths frequently consumes excessive bandwidth and may also cause oscillations. Therefore, routing path changes should only be performed at sufficiently long intervals. Unfortunately, a network cannot be responsive to short-term traffic bursts if only long-term updates are performed. For this reason, we use link costs measured over two different intervals; link costs measured over short intervals of length Tₛ are used for routing-parameter computation and link costs measured over longer intervals of length Tₗ are used for routing-path computation. In general, Tₗ must be several times longer than Tₛ. Long-term updates are designed to handle long-term traffic changes and are used by the routing protocol to update the successor sets at each router, so that the new routing paths are the shortest paths under the new traffic conditions. The short-term updates made every Tₛ seconds are designed to handle short-term traffic fluctuations that occur between long-term routing path updates and are used to compute the routing parameter φⱼₖⁱ in Eq. (15) locally at each router. Accordingly, our traffic distribution heuristics assume a constant successor set and successor graph.

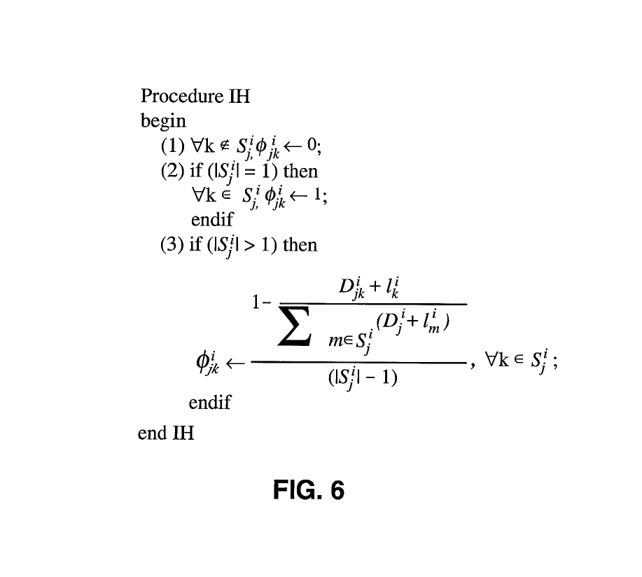

When Sⱼⁱ is computed for the first time or recomputed again due to long-term route changes, traffic should be freshly distributed. In this case, the allocation heuristic function ψ is a function of only the distances through the successor set. That is, Eq. (15) reduces to the form {φⱼₖⁱ}=ψ(k,{Dⱼ^{p}+lₚⁱ|pεNⁱ}). When a new successor set Sⱼⁱ is computed, algorithm IH in FIG. 6 is first used to distribute traffic over the successor set. Note that {φⱼₖⁱ}, computed in IH, satisfies Property 1. Furthermore, when more than one successor is present, if Dⱼₚⁱ+lₚⁱ>D_{jq}ⁱ+l_{q}ⁱ for successors p and q, then φⱼₚⁱ<φ_{jq}ⁱ. The heuristic makes sense because the greater the marginal delay through a particular neighbor becomes, the smaller the fraction of traffic that is forwarded to that neighbor.

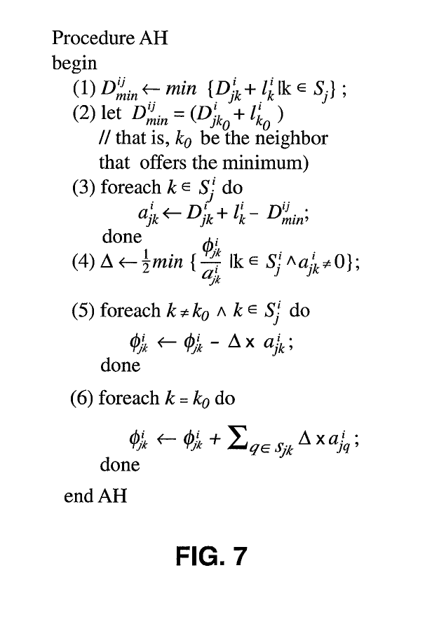

After the first flow assignment is made over a newly computed successor set using algorithm IH, a different flow allocation heuristic algorithm AH, shown in FIG. 7 is used to adjust the routing parameters every Tₛ seconds until the successor set changes again. The heuristic function ψ computed in AH is incremental and, unlike IH, is a function of current flow allocation on the successor sets and the marginal distance through the successors. AH also preserves Property 1 at every instant. In AH, traffic is incrementally moved from the links with large marginal delays to links with the least marginal delays. The amount of traffic moved away from a link is proportional to how the marginal link is compared to the best successor link. The heuristic tends to distribute traffic in such a way that Eq. (10) through Eq. (12) hold true. This is important, because the distribution obtained by IH is far from being balanced. The computational complexity of the heuristic allocation algorithms is O(Nⁱ). Since the heuristics are run for each active destination, the whole load-balancing activity is O(N).

Unlike η in Gallager's algorithm, Tₗ and Tₛ are constants that are set independently at each router. Convergence of our algorithm does not critically depend on these constants, which is contrary to the dependence on η required by optimal routing. In addition, Tₗ and Tₛ need not be static constants and can be made to vary according to the amount of congestion which exists at the router. The value of Tₗ, however, should be such that it sufficiently exceeds the time required for computing the shortest paths. The long-term update periods are should preferably be phased randomly at each router, because of the problems that would result due to synchronization of updates.

3.3 Computing Link Costs

The cost of a link, as was previously mentioned, is the marginal delay over the link D′(fᵢₖ). If the links are assumed to behave like M/M/1 queues, then the marginal delay D′(fᵢₖ) can be obtained in a closed form expression by differentiating the following equation:

$${D}_{ik} ( {f}_{ik} ) = \frac{{f}_{ik}}{{C}_{ik} - {f}_{ik}} + {τ}_{ik} {f}_{ik} \qquad ( 34 )$$

where fᵢₖ is the flow through the link (i,k), and Cᵢₖ and τᵢₖ are the capacity and propagation delay of the link. Since the M/M/1 assumption does not hold in practice in the presence of very bursty traffic, and because Eq. (24) becomes unstable when fᵢₖ approaches Cᵢₖ, an on-line estimation of the marginal delays is desirable.

There are several techniques for computing marginal delays that are currently available. For the purposes of simulations, a known technique introduced by Cassandras, Abidi, and Towsley is utilized for online estimation of the marginal delay D′(fᵢₖ). The technique uses perturbation analysis (PA) for the on-line estimation and is shown to perform better than M/M/1 estimation. In addition, the PA estimation does not require a priori knowledge of the link capacities. This is very significant, because the capacity available to best-effort traffic in real networks varies according to the capacity allocated to other types of traffic, such as real-time traffic. It should be appreciated that the approach of the present invention does not depend on which specific technique is used for marginal-delay estimation, although the effectiveness of these methods may vary from one to another. The convergence or stability of our routing algorithm does not depend on the specific technique used for marginal-delay estimation.

4. Simulations

This section presents results of simulation experiments designed to illustrate the effectiveness of the present invention when utilized in static and dynamic networks. The present approach is compared with a conventional approach, specifically the optimal routing approach and shortest-path routing based on Dijkstra's shortest-path first (SPF) algorithm, because it is used widely in the Internet today. The simulation results illustrate that the routing delays obtained with our new algorithm are comparable to the optimal delays. Furthermore, the complexity of implementing our routing framework is similar to the complexity of routing protocols that provide single-path routing in the Internet today.

The simulations discussed in this section illustrates the effectiveness of the near-optimal framework, and demonstrate the significant improvements achieved by the present inventive method over single-path routing in both static and dynamic environments. The delays obtained by optimal routing, single-path routing and our approximation method are compared under identical topological and traffic environments. The results show that the average delays achieved via our approximation method are comparable, within a small percentage, to the optimal routing under quasi-static environment and the same are significantly better than single-path routing in a dynamic environment.

For optimal routing, the algorithm described by Gallager was implemented and labeled as ‘OPT’. The plots of the approximation scheme are labeled with MP. In obtaining the representative delays for single-path routing algorithms, the multi-path routing algorithm was restricted to use only the best successor for packet forwarding, instead of simulating any specific shortest-path algorithm. As a result of the instantaneous loop freedom property that MPDA exhibits, the shortest-path delays obtained in this way are better than or similar to the delays obtained with either EIGRP, which is based on DUAL and requires much more internodal synchronization than our scheme, rendering longer delays, and RIP or OSPF which do not prevent temporary loops. The label “SP” is used in the graphs to denote single-path routing.

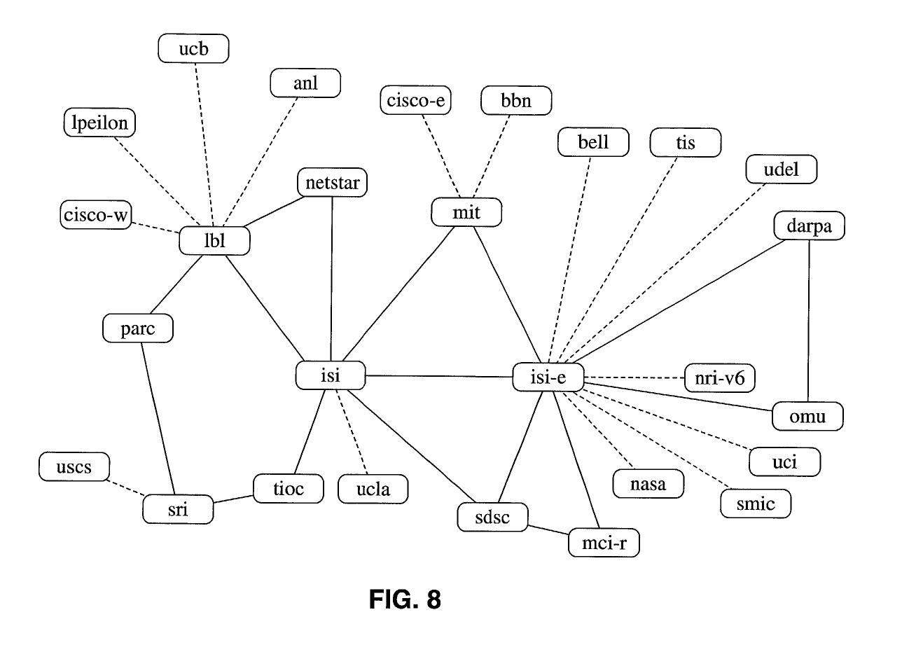

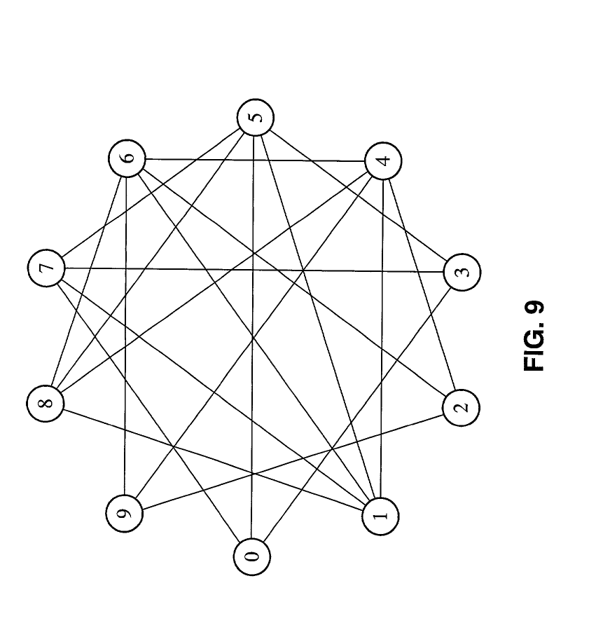

Simulations were performed on the topologies shown in FIG. 8 and FIG. 9. The topology of an actual network CAIRN, is shown in FIG. 8. A contrived network, referred to as NET1 is shown in FIG. 9. As only the connectivity of CAIRN is of interest, the topology as used differs from the real network in the capacities and propagation delays assumed in the simulation experiments. The consideration of link capacities was restricted to a maximum of 10 Mbps, to simplify the task of loading the network with sufficient traffic. NET1 has connectivity that is high enough to ensure the existence of multiple paths, and small enough to prevent a large number of one-hop paths. The diameter of NET1 is four and the nodes have degrees between three and five. Flows are established between several source-destination pairs in each network and the average delay of each flow is measured. The flows in CAIRN are setup between these source-destination pairs: (lbl, mci-r), (netstar, isie), (isie, netstar), (isi, darpa), (parc, sdsc), (sri, mit), (tioc, sdsc), (mit, sri), (isie, netstar), (sdsc, parc), (mci-r, tioc), (darpa, isi). For NET1, source-destination pairs are (9,2), (8,3), (7.0), (6,1), (5,8), (4,1), (3,8), (2,9), (1,6), (0,7).

The flows have bandwidths in the range from 0.2 through 1.0 Mbs. For the sake of simplicity, a stable topology was considered in all the simulations, wherein links and nodes are not subject to failure. In the presence of link failures, the performance of MP should be far superior to SP, as a result of the availability of alternate paths. Furthermore, OPT is not fast enough to respond to drastic topology changes. Yet since MP is parameterized by the Tₗ and Tₛ update intervals, its delay plots are represented by MP-TL-xx-TS-yy, where xx is the Tₗ update interval and yy is the Tₛ update interval, which is measured in seconds. Similarly, the delays of shortest-path routing are represented SP-TL-xx, where xx is the Tₗ update period.

4.1 Performance Under Stationary Traffic

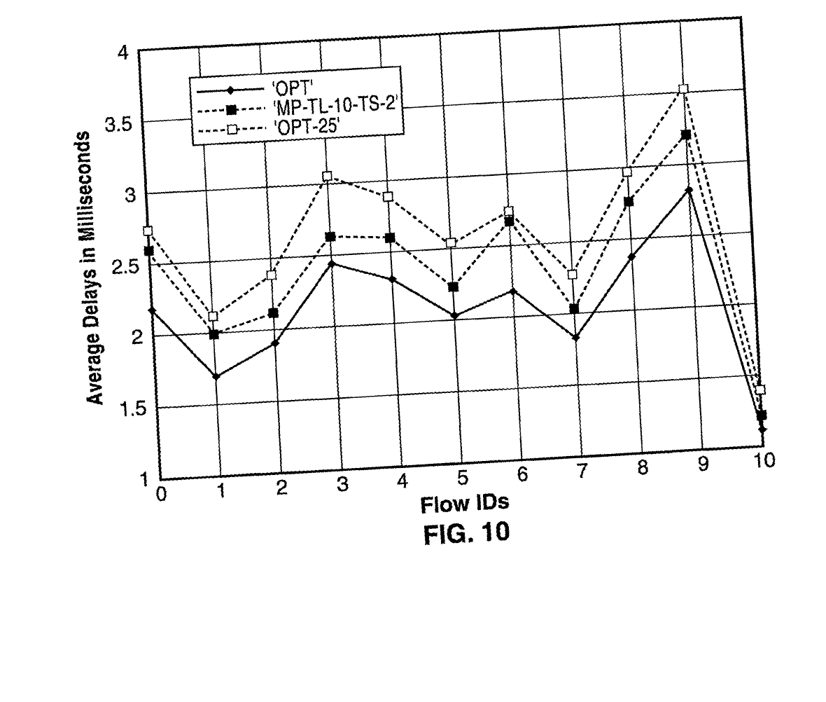

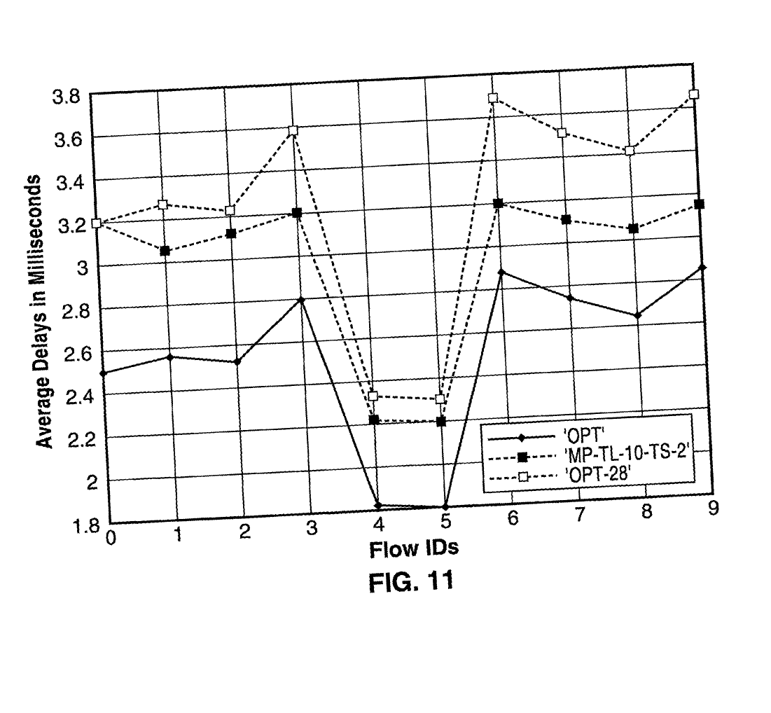

FIG. 10 illustrates the average delays of flows in CAIRN for OPT and MP routing. The flow IDs are plotted on the x-axis and average flow delays are plotted on the y-axis. Plot OPT-25 represents the 25%, ‘envelope’, that is, the delays of OPT are increased 25% to obtain the OPT-25 plot. As can be seen, the average delays of flows under MP routing are within the OPT-25 envelope. FIG. 11 illustrates in a similar manner that the delays obtained using MP routing for NET1 are within the 28% envelopes of delays obtained using OPT routing. The delays of MP can be said to be ‘comparable’ to OPT if the delays of MP are within a small percent of those of OPT.

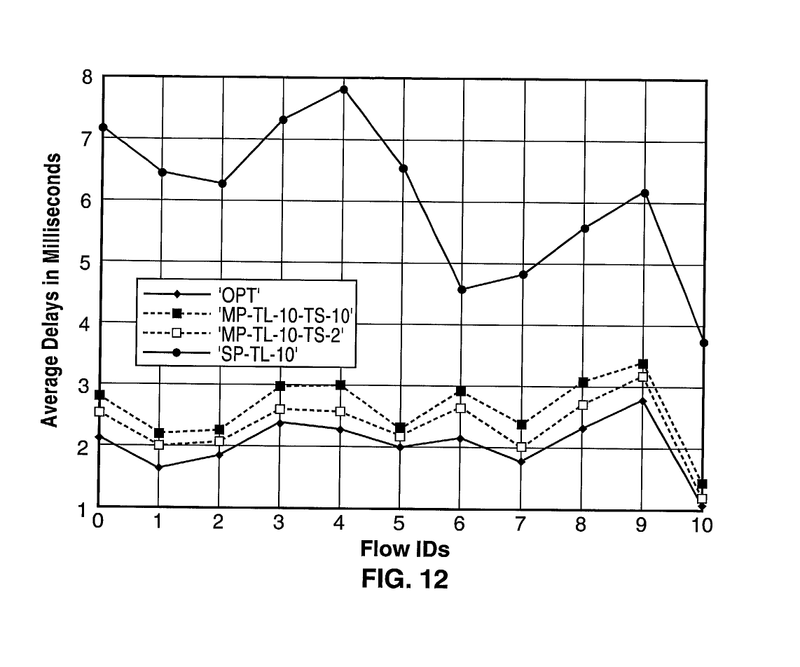

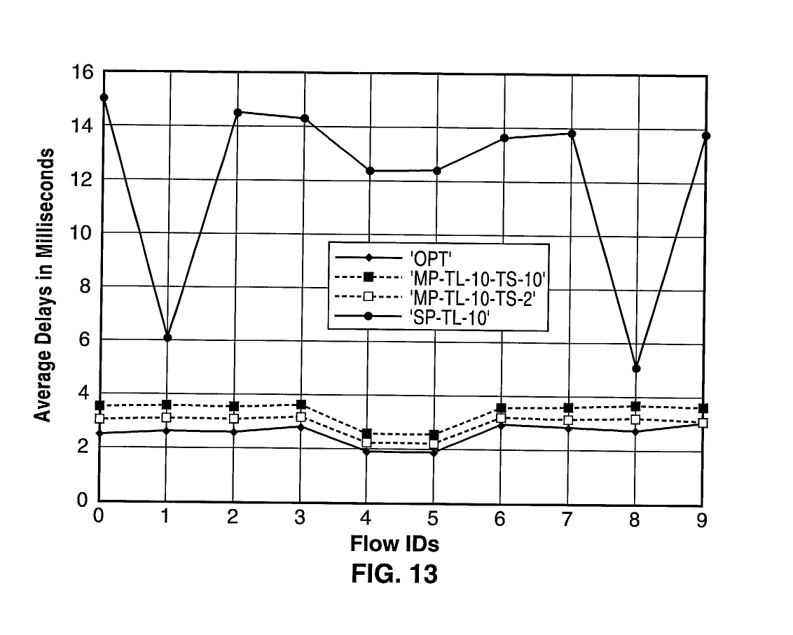

FIG. 12 compares the average delays of MP and SP for CAIRN. It was observed that the delays of SP for some flows are two to four times longer than those of MP. FIG. 13 indicates that for NET1, MP routing performs even better, with average delays of SP as much as five to six times those of MP routing. This can be explained by the higher connectivity available in NET1. It was also observed that because of load-balancing used in MP, the plots of MP are less jagged than those of SP. It will be appreciated that MP routing performance provided a significant improvement over SP routing under high-connectivity and high-load environments. When network connectivity is low, or the network load is light, MP routing does not offer any advantages over SP.

4.2 Effect of Tuning Parameters Tₗ and Tₛ

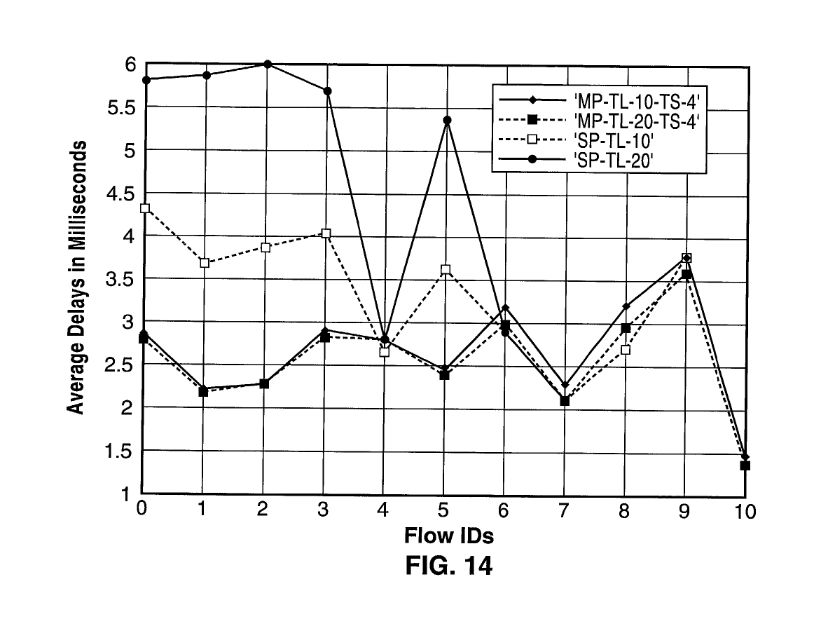

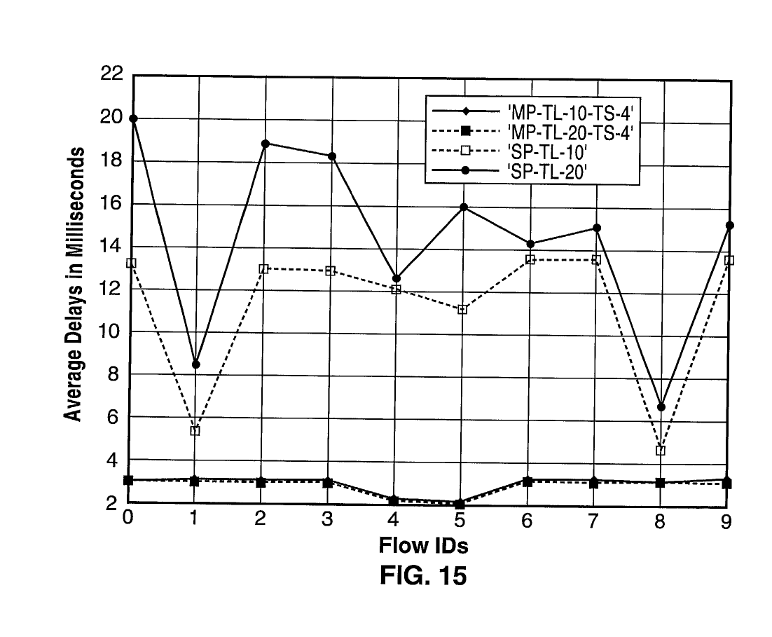

The performance of MP depends on the update intervals Tₗ and Tₛ, which are easily set parameters of MP. These values are local and can be set independently at each node without affecting convergence, unlike the global constant η which is critical for convergence of OPT. FIG. 14 illustrates, for CAIRN, the effect of increasing Tₗ when both Tₛ and the input traffic remain fixed. It should be noted that when Tₗ is increased from 10 to 20 seconds, the associated delays in SP increase by more than double, while the delays in MP remain relatively unaffected. This effect indicates that Tₗ can be extended within MP without significantly effecting performance. This is significant because sending frequent update messages consumes bandwidth and can also cause oscillations under high load conditions. FIG. 15 illustrates a similar situation for NET1, wherein delays for SP increased significantly while there negligible delay changes occurred with MP. The routing method of the present invention, therefore, is seen to provide the means for trading-off between message updating and local load-balancing.

At Tₛ intervals, the load-balancing heuristics are executed, which are strictly local computations and require no communications. Therefore, Tₛ can be set according to the processing power available at the router. The setting of Tₗ can be adjusted from values approximating Tₛ on up to values which exceed Tₛ by orders of magnitude. In a simple case Tₗ can be set to the same value as Tₛ, while still gaining significant performance as shown in FIG. 12 and FIG. 13. It can be observed in the figures that MP-TL-10-TS-10 is much closer to OPT than SP-TL-10. Just the long-term routes with load balancing, without short-term routing parameter updates appear to provide performance gains, while the major gains appear to be due to the presence of multiple successors and the effect of load-balancing. The experience gained from the simulations suggests that a Tₗ value that is only a few times larger than Tₛ can be sufficient to garner significant benefits. It should be appreciated, therefore, that fine tuning of Tₗ and Tₛ is not necessary to achieve efficient operation of the method.

4.3 Performance Under Dynamic Traffic

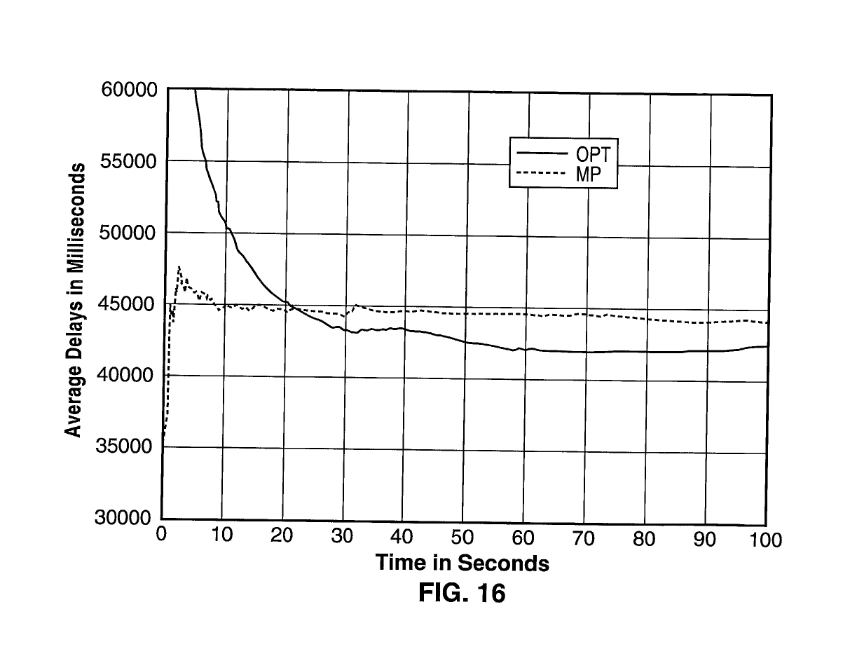

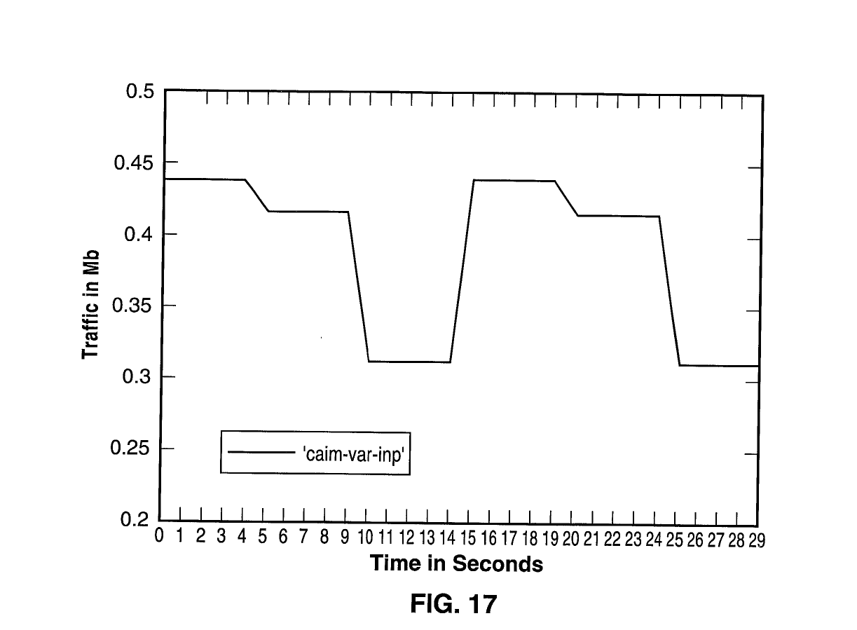

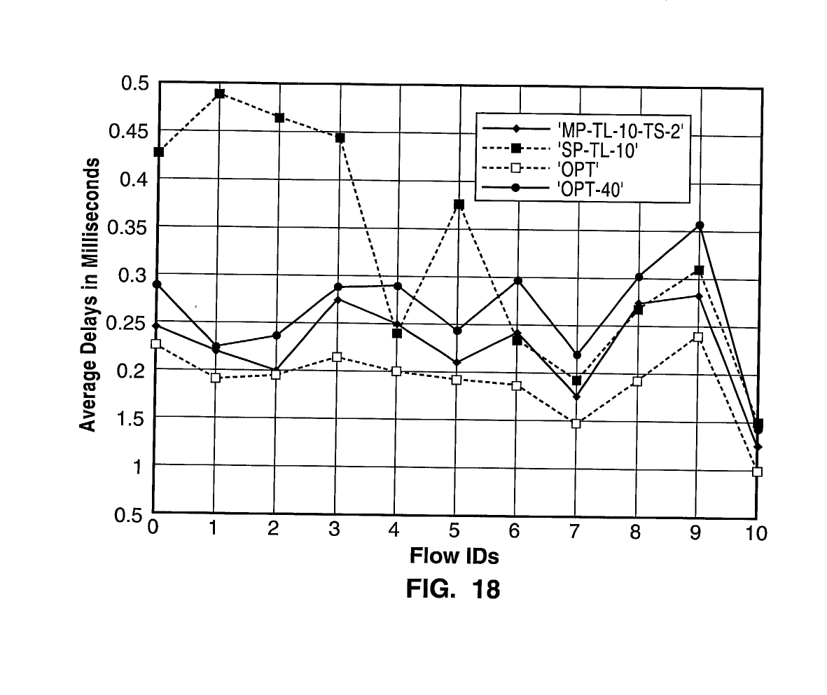

The poor response of OPT to traffic fluctuations is evident in FIG. 16, which illustrates a typical response in NET1 when the flow rate is modeled as a step function, wherein the flow rate changes from zero to a finite amount at time zero. The dampened response of the network using MP indicates the fast responsiveness of MP, making it suitable for dynamic environments. OPT cannot respond fast enough to traffic fluctuations, therefore, it is unable to find the optimal delays for dynamic traffic. However, a reasonable lower bound may be found if the input traffic pattern is predictable such as the pattern shown in FIG. 17, which illustrates only one cycle of the input pattern. In obtaining a lower bound for this traffic pattern to represent “ideal” OPT, which would have instantaneous response, the lower bound for each interval is first obtained during which traffic is steady by running a separate off-line simulation with traffic rate that corresponds to that interval, and combining the results to obtain a lower bound. It is with this lower bound value that delays of MP are compared. FIG. 18 illustrates average delays from flows for OPT, MP, and SP routing. The results indicate that delays of MP routing are again in the comparable range of delays of an “ideal” optimal-routing algorithm.

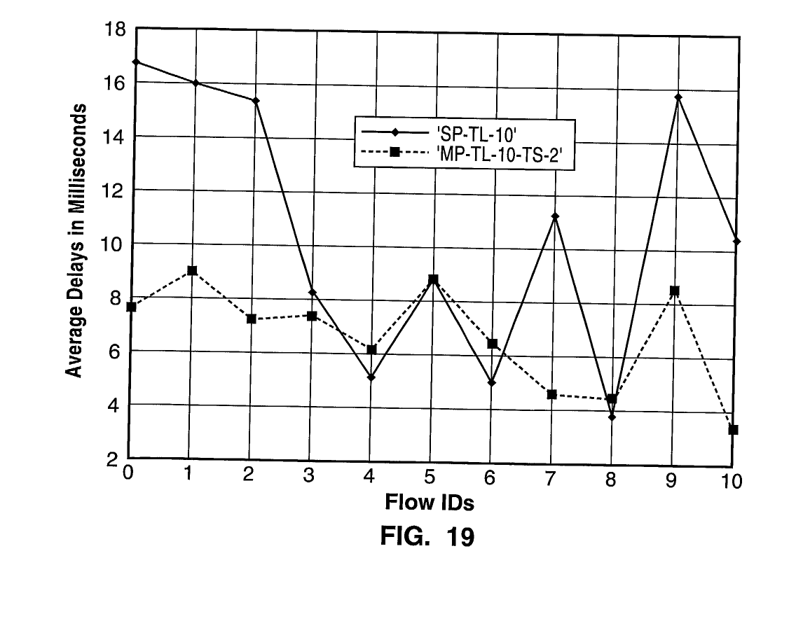

MP is intended for use in real networks in which traffic may be considered bursty within any given time-scale. It is important, therefore, to evaluate the performance of MP in the environment of a real network. Therefore, ten flows from the Internet traffic traces obtained from LBL were used as input for the ten flows in the CAIRN. FIG. 19 depicts a comparison of delays between SP and MP. The simulation is not performed with OPT as the burstiness of the internet traffic prevents OPT convergence. It should be noted, that except for flows 4, 6, and 8, delays resulting from the use of MP are generally far less than those experienced with SP. The reason SP delays for certain flows is less than MP is because of uneven distribution of load in the network and low loads in some sections of the network. The present simulations indicate that at low-load environments SP is capable of slightly outperforming MP, however, this can be rectified by modifying IH to use a small threshold cost for the best link, the crossing of which actually triggers the load-balancing scheme.

5. Conclusions

A practical approximation method has been described which is directed toward the achievement of near-optimal routing in a computer network. The method along with various implementation aspects have been described which may be applied for use in real networks. One important element of the method that is applicable to any type of routing algorithm or method is the generalization of sufficient conditions necessary to obtain loop-free routing. Simulations indicate that the method of the present invention can provide a significant performance increase over single-path routing, and that it offers delays that are within a small percentage of the lower bound delays under stationary traffic conditions. Although the simulations performed were not exhaustive, the results obtained clearly indicate that the method can provide delays comparable with an optimal routing method.

Accordingly it will be seen that the method of the present invention is a routing method which is capable of increasing the performance of network traffic routing. The inventive method has been exemplified within a single embodiment, however, it will be appreciated that one of ordinary skill in the art will be able to modify the present method in a number of ways without departing from the teachings of the present invention.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of routing traffic between a source router and a destination router within a multi-path network, comprising:
determining multiple loop-free paths of unequal cost to a destination router in response to long-term link-cost information;
allocating a route to said destination router along one of said multiple loop-free paths; and
adjusting routing parameters available at each router in response to short-term link-cost information to incrementally adjust route allocation.

2. A method as recited in claim 1, wherein said long-term link-cost information is determined within said routers by executing heuristic programming to update successor set information at each router.

3. A method as recited in claim 1, wherein said short-term link-cost information is determined within said routers by executing heuristic programming to update routing parameters at each router.

4. A method as recited in claim 1, wherein said short-term link-cost information is computed by each router in response to information received within link-state update messages, or equivalent.

5. A method as recited in claim 4, wherein said link-state update message indicates that an addition, deletion, or change in link-costs has occurred.

6. A method as recited in claim 1,
wherein allocating of said route does not require global synchronization on the network;
whereby said routing method is able to respond to rapidly-changing traffic conditions within said network.

7. A method as recited in claim 1,
wherein said short-term link-cost information is gathered at intervals of length Tₛ; and
wherein said short-term link-cost information is utilized to adjust the routing-parameters of routers along said loop-free path.

8. A method as recited in claim 1,
wherein said long-term link-cost information is gathered at intervals of length Tₗ;
wherein said long-term link-cost information is used to update successor set information for each router; and
wherein said long-term link-cost information is utilized for initializin g a near-optimum routing path.

9. A method as recited in claim 1, wherein short-term and long-term link-cost information is maintained in tables at each router.

10. A method as recited in claim 9, wherein said tables comprise:
a main topology table Tⁱ, or equivalent, in which information is maintained about the characteristics of each link known to router i;
a neighbor topology table Tₖⁱ, or equivalent, in which information is maintained about each neighbor k;
a distance table in which distance information is maintained from router i to each destination based on the topology in said main topology table;
a routing table in which information about routing paths to the destinations are maintained; and
a link table in which link-cost information lₖⁱ is maintained for each neighbor k.

11. A method as recited in claim 10, wherein the routing path information maintained in said routing table comprises:
successor set Sⱼⁱ to each destination j; and
feasible distance FDⱼ ⁱ.

12. A method as recited in claim 1,
wherein the traffic allocation on a link substantially satisfies the following equation: φⱼₖⁱ=ψ(k,{Dⱼ^{p}+lₚⁱ|pεNⁱ}, φⱼₚⁱ|pεNⁱ}) kεNⁱ, where Oⱼₖⁱ is the routing path parameter and where ψ is a flow allocation function.

13. A method as recited in claim 1, wherein determining of multiple loop-free paths is performed according to an approximation of minimum delay routing.

14. A method of approximating minimum delay routing between a source and a destination within a computer network having a plurality of available paths, comprising:
deriving an approximation to the Gallager minimum-delay routing problem to determine near-optimal routes between said source and said destination; and
allocating routes according to said approximation based on link-state information so as to provide multiple paths of unequal cost to each destination that are loop-free.

15. A method as recited in claim 14, wherein said link-state information comprises:
long-term link information containing information about the near-shortest routing path;
said long-term link information further containing information about successor sets at each router; and
short-term link information containing recent information about that state of the links for use in adjusting routing parameters at each router.

16. A method as recited in claim 15, wherein said short-term link information is updated more frequently than the long-term link information.

17. A method as recited in claim 15, wherein said short-term link-cost information is computed by each router in response to information received within link-state update messages, or equivalent.

18. A method as recited in claim 15, wherein said link-state update messages indicate that an addition, deletion, or change in link-costs has occurred.

19. A method as recited in claim 14,
wherein the derivation of said near-optimal routes does not require global synchronization on the network;
whereby said routing method can respond to rapidly-changing traffic conditions.

20. A method as recited in claim 19,
wherein global variables for the network do not need to be maintained.

21. A method as recited in claim 15, wherein short-term and long-term link-cost information are maintained in a series of tables at each router.

22. A method as recited in claim 21, wherein said tables, comprise:
a main topology table Tⁱ, or equivalent, in which information is maintained about the characteristics of each link known to router i;
a neighbor topology table Tₖⁱ, or equivalent, in which information is maintained about each neighbor k;
a distance table in which distance information is maintained from router i to each destination based on the topology in said main topology table;
a routing table in which information about routing paths to the destinations are maintained; and
a link table in which link-cost information lₖⁱ is maintained for each neighbor k.

23. A method as recited in claim 22, wherein the routing path information maintained in said routing table comprises:
successor set Sⱼⁱ to each destination j; and
feasible distance FDⱼⁱ.

24. A method as recited in claim 23, wherein said tables are maintained within by the executing of procedures within said routers, comprising:
a main topology update procedure (MTU), or equivalent;
a multiple-path partial-topology dissemination procedure (MPDA), or equivalent, which is invoked when an event occurs to disseminate topology information to routers;
an initializing procedure for said multiple-path partial-topology dissemination procedure (INIT-PDA), or equivalent;
a neighbor topology update procedure (NTU) for updating the topology of neighboring routers;
initial route assignment procedure (IH) for allocating a near-optimal initial route between a source and a destination according to said long-term link-cost information; and
an incremental loading procedure (AH) which adjusts routing parameters according to said short-term link-cost information.

25. A method of allocating loop-free multi-path traffic routing between routers within a network having a plurality of routing paths between said source and said destination, comprising:
computing multiple loop-free paths between said routers;
distributing traffic over said loop-free paths; and
updating link costs associated with said paths to optimize local traffic flow.

26. A method as recited in 25, wherein the computing of said loop-free paths comprises:
computing Dⱼⁱ using a shortest-path algorithm, or equivalent, based on link-state information; and
computing Sⱼⁱ by extending said shortest-path algorithm to support multiple successors along the loop-free path to each destination.

27. A method as recited in 25, wherein distributing traffic over said paths comprises:
executing a heuristic algorithm IH, or equivalent, to determine an initial load assignment; and
periodically executing a heuristic algorithm AH, or equivalent, to adjust the incremental load.

28. A method as recited in 25, wherein updating link costs associated with said paths to optimize local traffic flow comprises:
estimating marginal delay along each path; and
communicating link-state update messages (LSUs) which contain information about said marginal delay along said paths.

29. A method of approximating minimum delay between routers within a computer network having a plurality of available paths by executing a distributed routing algorithm, comprising:
determining a set of marginal distances Dⱼⁱ=min{Dⱼ^{k}+lₖⁱ|kεNⁱ};
finding a feasible distance FDⱼⁱ which satisfies the relationship FDⱼⁱ≦Dⱼᵢ^{k} wherein kεNⁱ;
determining a successor set Sⱼⁱ={k|Dⱼₖⁱ<FDⱼⁱΛkεNⁱ} or equivalent; and
allocating traffic φⱼₖⁱ=ψ(k,{Dⱼ^{p}+lₚⁱ|pεN^{i}, {φ}ⱼₚⁱ|pεNⁱ}) wherein kεNⁱ, or equivalent along said routes;

30. A method of assuring loop-free routing by a router executing a given routing algorithm and operated within a network having multiple paths between sources and destinations, comprising:
finding a feasible distance FDⱼⁱ which satisfies the relationship FDⱼⁱ≦Dⱼᵢ^{k} wherein kεNⁱ;
determining a successor set Sⱼⁱ={k|Dⱼₖⁱ<FDⱼⁱΛkεNⁱ} or equivalent; and
wherein any routing path satisfying the above equations is assured of being a loop-free routing path within said network.
